(19) United States
(12) Patent Application Publication
(10) Pub. No.: US 2010/0086450 A1
(43) Pub. Date: Apr. 8, 2010

(54) METHOD AND APPARATUS FOR PREPARING CATALYST SLURRY FOR FUEL CELLS

(75) Inventors: Nak Hyun Kwon, Seoul (KR); In Chul Hwang, Seongnam (KR); Byung Ki Ahn, Seongnam (KR); Tae Won Lim, Seoul (KR)

Correspondence Address: EDWARDS ANGELL PALMER & DODGE LLP, P.O. BOX 55874, BOSTON, MA, 02205, US

(73) Assignee: HYUNDAI MOTOR COMPANY, Seoul (KR)

(21) Appl. No.: 12/625,531

(22) Filed: Nov. 24, 2009

Related U.S. Application Data
(62) Division of application No. 12/499,997, filed on Jul. 9, 2009.

(30) Foreign Application Priority Data
Oct. 6, 2008 (KR) 10-2008-0097557

(51) Int. Cl. B01J 19/10

(52) U.S. Cl. 422/128

(57) ABSTRACT

The present invention relates to a method and apparatus for preparing a catalyst slurry for fuel cells, in which nano-sized catalyst particles are dispersed uniformly at a high concentration and the adsorption force between the catalyst and ionomer is maximized. The resulting catalyst slurry is suitable for the manufacture of a membrane-electrode assembly (MEA) of a polymer electrolyte (or proton exchange) membrane fuel cell (PEMFC).

### CROSS-REFERENCE TO RELATED APPLICATION

This application claims the benefit under 35 U.S.C. §119(a) of Korean Patent Application No. 10-2008-0097557, filed on Oct. 6, 2008, the entire contents of which are incorporated herein by reference.

### BACKGROUND

(a) Technical Field

The present disclosure relates to a method and an apparatus for preparing a catalyst slurry for use in fuel cells, in which nano-sized catalyst particles are dispersed uniformly at a high concentration and the adsorption force between the catalyst and ionomer is maximized.

(b) Background Art

The development of a high-performance electrode is indispensable for the development of a membrane-electrode assembly (MEA) for use in fuel cells such as a polymer electrolyte (or proton exchange) membrane fuel cell (PEMFC). In order to obtain such an electrode, a catalyst slurry (CS) with high dispersity and flowability is required. Consequently, intensive researches have been made to develop a method of preparing such a catalyst slurry.

As catalyst particles used to prepare fuel cells have large specific surface area and small particle size (i.e., nano-sized), it is not easy to provide such a catalyst slurry. Although some methods and apparatuses were proposed for dispersing nano-sized catalyst particles at a low concentration, no method for dispersing nano-sized catalyst particles at a high concentration has been proposed.

In addition, increased adsorption force between the catalyst and ionomer helps to provide fuel cells having high use efficiency of the catalyst A research team led by professor Watanabe in Japan proposed a method in which ionomers adsorbed to catalyst particles are put into primary pores of a catalyst support by applying a high pressure upon dispersion of a catalyst slurry. This method, however, has drawbacks that it is complicated, air layers inside the primary pores cannot be completely removed, and complete infiltration of the ionomers into the support is difficult, among others.

The information disclosed in this Background section is only for enhancement of understanding of the background of the invention and should not be taken as an acknowledgment or any form of suggestion that this information forms the prior art that is already known to a person skilled in that art.

### SUMMARY

An object of the present invention is to provide a method and apparatus for preparing a catalyst slurry for fuel cells, in which a vacuum degassing process is introduced in the preparation of the catalyst slurry so that ionomers are infiltrated into and adsorbed onto the primary pores of a catalyst support to induce a metallic catalyst formed in the primary pores to participate in the reaction, thereby increasing the catalyst utilization, as well as so that respective surface potentials of catalyst particles including the catalyst support are increased to improve dispersity of the catalyst particles in a solvent and flowability of the catalyst slurry.

In one aspect, the present invention provides a method for preparing a catalyst slurry for fuel cells, the method comprising: (a) charging a solvent, an ionomer and catalyst particles into a reactor and dispersing the catalyst particles through ultrasonic waves and high-speed stirring; (b) allowing the ionomer to be infiltrated into and adsorbed onto primary pores existing in the catalyst particles by maintaining the reactor in a vacuum state; (c) removing air bubbles produced in step (b) and (d) filtering catalyst particles having a particle size larger than a reference particle size.

In another aspect, the present invention provides an apparatus for preparing a catalyst slurry for fuel cells, comprising: a reactor for accommodating a solvent and a catalyst therein; an ultrasonic generator and a high-speed stirrer which are connected to the reactor so as to uniformly disperse the catalyst to a predetermined particle size in the solvent; and vacuum maintaining means connected to the reactor so as to maintain the internal pressure of the reactor in a vacuum state.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other aspects and features of the invention are discussed infra.

### BRIEF DESCRIPTION OF THE DRAWINGS

FIG. 1 is a schematic view illustrating a catalyst particle dispersion model according to the present invention;

FIG. 2 is a diagrammatic view illustrating the construction of an apparatus for preparing a catalyst slurry according to an embodiment of the present invention;

FIG. 3 is a graph illustrating nanopore distribution curves analyzed by a specific surface area analyzer (BET) for comparison of the effect of bead milling time on porosity of an electrode layer during a catalyst slurry dispersion process according to the present invention;

FIG. 4 is a graph illustrating the comparison of the effect of bead milling time on fuel cell performance during a catalyst slurry dispersion process according to the present invention;

FIG. 5 is a graph illustrating a particle size distribution with respect to a catalyst slurry prepared by a process according to an embodiment of the present invention;

FIG. 6 is a graph illustrating the comparison of I-V performances of the fuel cell including an electrode catalyst made by using a catalyst slurry prepared by a process according to an embodiment of the present invention and the fuel cell including an electrode catalyst made by using a prior art dispersion method; and

FIG. 7 is a block diagram illustrating a method for preparing a catalyst slurry according to the present invention.

Reference numerals set forth in the Drawings includes reference to the following elements as further discussed below:

10: reactor
11: vacuum pump
12: chiller
13: condenser
14: spray nozzle
15: ultrasonic probe
16: water supply pump
17: homogenizer
18: filter
19: bead milling machine
20: storage tank
21: ultrasonic generator
22: hopper
23: high-speed stirrer
24: air escape tube

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

As discussed above, high flowability and dispersity of a catalyst slurry are indispensable for the design of a catalyst layer (CL) of an MEA for fuel cells. To reduce overall manufacturing costs, the catalyst layer should be prepared by performing a single coating process.

The present inventors have recognized the importance of the step of dispersing catalysts in the development of an MEA for fuel cells and identified a catalyst particle dispersion model. The present invention provides processes and apparatuses for preparing a highly dispersed catalyst slurry based on the dispersion model.

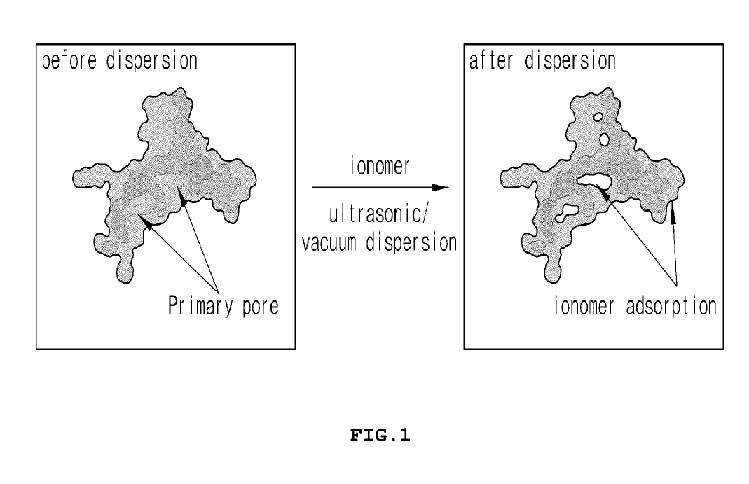

The catalyst dispersion model is described hereinafter with reference to FIG. 1. In order to maximize the utilization of exposed portions of nano-sized metal catalyst particles as well as the utilization of the metal catalyst particles in primary pores (200 nm or lower) of a catalyst support, the catalyst layer is designed such that an ionomer acting as a proton transfer medium in the electrode layer is infiltrated into and adsorbed onto the primary pores of the catalyst support to induce the metallic catalyst in the primary pores to participate in the fuel cell reaction. Further, respective surface potentials of catalyst particles including the catalyst support are increased, thereby optimizing the dispersity of the catalyst particles.

In general, catalyst particles agglomerate together by the electrostatic attraction in the air to exist in a particle size of several to several tens of μm. When a solvent and an ionomer are added to the catalyst particles and the catalyst particles are dispersed through ultrasonic waves and high-speed stirring, most of the catalyst particles are uniformly dispersed with a particle size of 0.4 to 2.0 μm.

Nevertheless, some of the catalyst particles are difficult to be dispersed and they exist in a large particle size of 10 μm or more. Particularly, a greater amount of large particles can exist when the dispersion concentration is 10 wt % or higher. This may deteriorate coatability in the coating process of an electrode catalyst layer upon the preparation of the MEA, thereby decreasing the catalyst utilization and MEA performance. In addition, even when the catalyst particles are highly dispersed so as to increase the catalyst utilization, it may still be difficult to use the catalysts inside the primary pores (100 nm or less) of Pt/C catalyst particles (d.=350 nm).

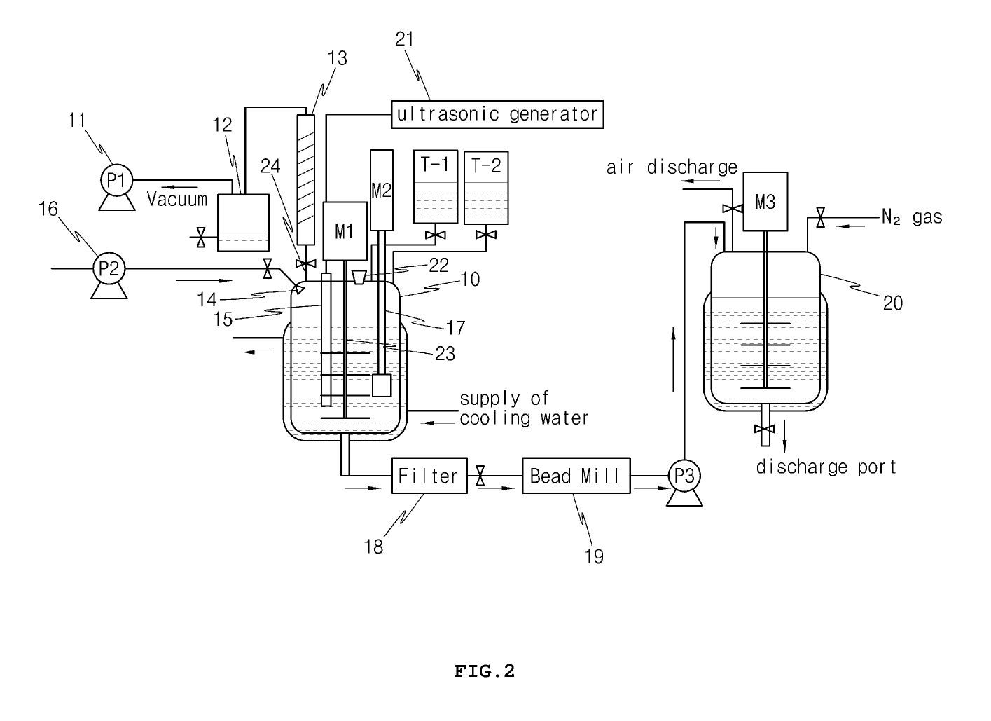

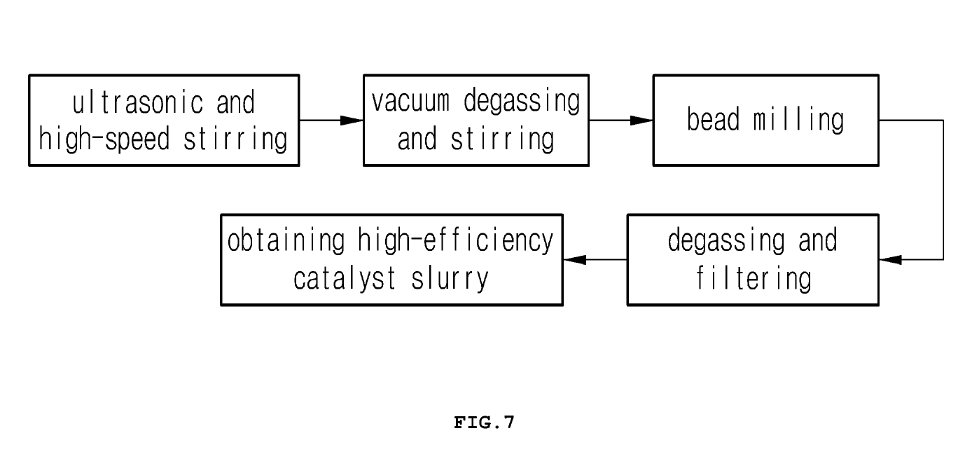

To solve the issue and maximally increase catalyst dispersity and catalyst utilization, a vacuum degassing process is introduced in the preparation of the catalyst slurry (see FIGS. 2 and 7). When a vacuum state is created during the dispersion process of the catalyst particles, oxygen bubbles adsorbed onto the surfaces of the catalyst particles are slowly removed and simultaneously oxygen bubbles inside primary pores slowly escape into a solvent, so that the spaces from which the oxygen bubbles are removed and escaped are gradually wet with the solvent. As a result, the overall contact surface of the catalyst particles exposed to the solvent increases.

Furthermore, dispersity of the catalyst particles in the solvent is improved and flowability of the catalyst slurry is enhanced. Besides, an ionomer dispersed in the solvent is easily infiltrated into the primary pores (tens of nanometers in diameter). Consequently, the adsorption rate of the ionomer into the primary pores is increased and the utilization of the catalyst is thus increased.

An apparatus for preparing a catalyst slurry according to an embodiment of the present invention is described with reference to FIG. 2. The apparatus includes a reactor 10, a spray nozzle 14 vacuum maintaining means, a high-concentration catalyst dispersion device, a filter 18, and a bead milling machine 19. The vacuum maintaining means includes a condenser 13, a chiller 12, and a vacuum pump 11, and the high-concentration catalyst dispersion device includes an ultrasonic generator 21, an ultrasonic probe 15, and a homogenizer 17, as shown in FIG. 2. They help dispersion of high-concentration catalyst and nano-particles, and the vacuum maintaining device, in particular, helps infiltration of ionomers into the primary pores of catalyst.

In the preparation of a catalyst slurry, when a solvent (e.g., alcohols such as IPA) comes into direct contact with a catalyst (e.g., Pt), ignition may be triggered. One method typically used in the art to prevent this ignition is to cool the solvent to about 5□ and disperse the catalyst particles little by little in the cooled solvent.

In order to prevent such ignition, in the present invention, catalyst powder is added into the inside of a reactor by using a hopper installed on the upper end of the reactor. Then, water is sprayed onto a catalyst powder using the spray nozzle 14 so as to evenly wet the catalyst powder.

In addition, the apparatus may further include an ultrasonic generator 21, an ultrasonic probe 15, a high-speed stirrer 23 and a homogenizer 17. The high-speed stirrer 23, being driven by M1 (motor), uniformly disperses catalyst, and the ultrasonic waves generated therefrom are delivered to a mixed solution (a mixture of catalyst powder and a solvent) present inside a reactor via ultrasonic probe 15, thereby assisting dispersion of nanoparticles, and homogenizer 17 is used to uniformly disperse large particles.

The apparatus may further include air escape tube 24, a vacuum pump 11, a chiller 12 and a condenser 13 which are designed to maintain a vacuum state during the catalyst dispersion in order to increase high catalyst dispersity and utilization. The air escape tube 24 is installed on the upper end of the reactor 10. It is connected to the vacuum pump 11, the chiller 12 and the condenser 13, and the air contained inside the reactor 10 is released through the air escape tube 24, being condensed by passing through the condenser 13 and the chiller 12 and then released to the outside by the vacuum pump 11.

The filter 18 is used to filter catalyst particles having a particle size of 10 μM or more among the catalyst particles dispersed by the apparatus.

The bead milling machine 19 is used to perform a bead milling process by which non-dispersed large-sized catalyst particles are re-dispersed, thereby optimizing dispersion of catalyst particles.

A method for preparing a catalyst slurry according to an embodiment of the present invention is described with reference to FIG. 7.

As shown in FIG. 7, the method includes the steps of: dispersing catalyst particles through the ultrasonic generator 21 and the high-speed stirrer 23; removing air bubbles from the primary pores of a catalyst support and simultaneously allowing ionomer dispersed in a solvent to be infiltrated into and adsorbed onto the primary pores by stirring the catalyst particles with the stirrer 23 and simultaneously maintaining the internal pressure of the reactor 10 in a vacuum state using the vacuum pump 11; dispersing coarse catalyst particles remained in a small amount through the bead milling machine 19; and removing remaining air bubbles generated when stirring and filtering catalyst particles having a size larger than a predetermined value, thereby producing a high-efficiency catalyst slurry.

The thus obtained high-efficiency catalyst slurry may be optimally designed taking into consideration the kind of a catalyst, a dispersion solvent, a binder and an additive, and the respective ratio thereof based on the result of measurement of physical properties and electrochemical evaluation of the prepared catalyst slurry.

According to the above-described apparatuses and methods, the catalyst slurry can be consecutively prepared in a batch process at a high concentration, the adsorption rate of the catalyst particles and the ionomer can be increased, and the catalyst slurry can be prepared in a simple, easy and safe manner which can facilitate mass production. Also, as the high-concentration catalyst slurry is prepared, a catalyst layer can be formed through a single coating process, which makes it possible to manufacture the electrodes of an MEA for use in fuel cells with a high productivity and in a cost-effective way. In addition, with the methods, the following problems associated with a prior art method for preparing an electrode for use in fuel cells, in which the electrode is prepared by spray-coating a low-concentration catalyst slurry: e.g., loss of the catalyst is great and coating process must be performed several times, thereby decreasing overall productivity. Moreover, the apparatuses can be applied to virtually all kinds of catalyst particles.

### Examples and Comparative Examples

The structure of pores of a catalyst layer (CL) according to bead milling time and the resulting fuel cell performance change were tested [test conditions: 70 mL of CS (ratio of PtC to ionomer=1:0.35, concentration=10 wt %), 250 g of added beads (d.=2 mm), and 50 rpm of milling speed].

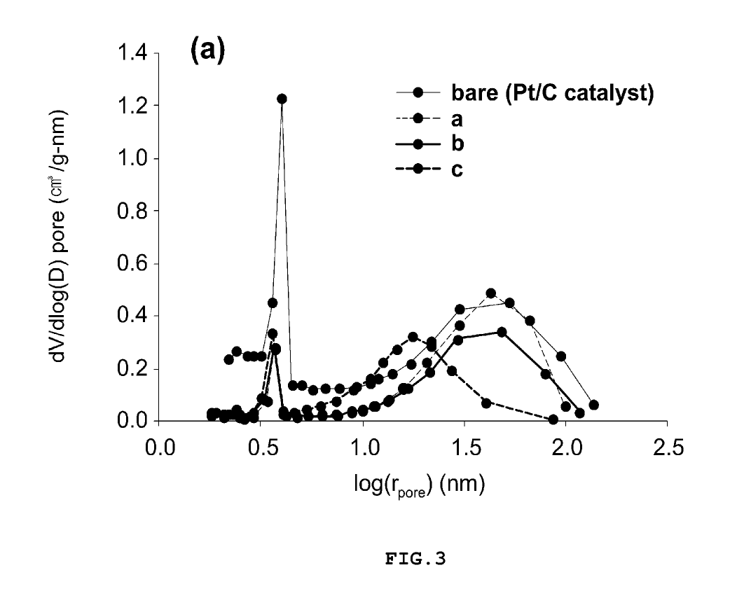

FIG. 3 is a BET-based analysis result that shows the size and size distribution of nanopores formed by subjecting to bead milling, drying and fine pulverization. The pore surface area, the pore volume and the average pore diameter of the catalyst particles were measured and are shown in Table 1 below. The terms a, b and c in FIG. 3 and Table 1 are used to mean samples obtained by bead milling for 0.5 hour, 3 hours and 7 hours, respectively. The term “bare” is used to mean a sample obtained without bead milling.

TABLE 1

| | Surface are^{a} | Pore volume^{b} | Average pore |
|---|---|---|---|
| sample | (m²/g) | (cm³/g) | diameter^{c} (nm) |
| bare (Pt/C) | 242.73 | 0.5551 | 9.10 |
| a | 57.88 | 0.3387 | 19.98 |
| b | 56.56 | 0.2057 | 15.72 |
| c | 60.27 | 0.2085 | 10.47 |

^{a}Bet surface area,
^{b,c}BJH desorption (pore range = 1.7~300 nm)

As shown in FIG. 3 and Table 1, the number of pores with a size ranging from 10 to 100 nm in the sample a was similar to that of the bare sample. In contrast, the porosity (i.e., average size and area of pore prepared inside a catalyst layer after the formation of the catalyst layer) of the samples b and c was greatly reduced. Particularly, for the sample c, the number of pores with a size ranging from 40 to 100 nm was greatly reduced and the number of pores with a size ranging from 10 to 40 nm was increased relatively.

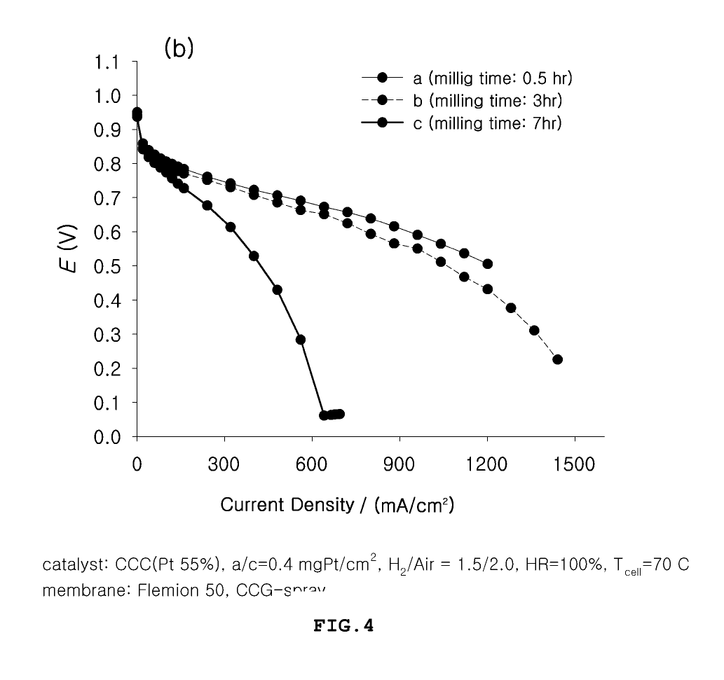

MEAs were prepared by using the bare sample and samples a, b and c to compare the respective cell performances. As shown in FIG. 4, the MEA prepared by the sample a showed excellent cell performance. The cell performance of the MEA prepared by the sample b was better than that of the MEA prepared by the sample c. When milling was not performed, large particles were generated in the catalyst slurry, thus deteriorating the surface state when coating catalyst layer, and also lower the output.

These results imply that it is important to optimize the bead milling operation. Although the test results here showed that 0.5 hour of milling time was optimal, optimal milling time can be changed depending on conditions.

### Test Example

The size distributions of the catalyst particles of a catalyst slurry prepared by a process according to the present invention and a catalyst slurry prepared by a high-speed stirring dispersion method known in the art were measured to compare the degrees of dispersity of the catalyst slurries.

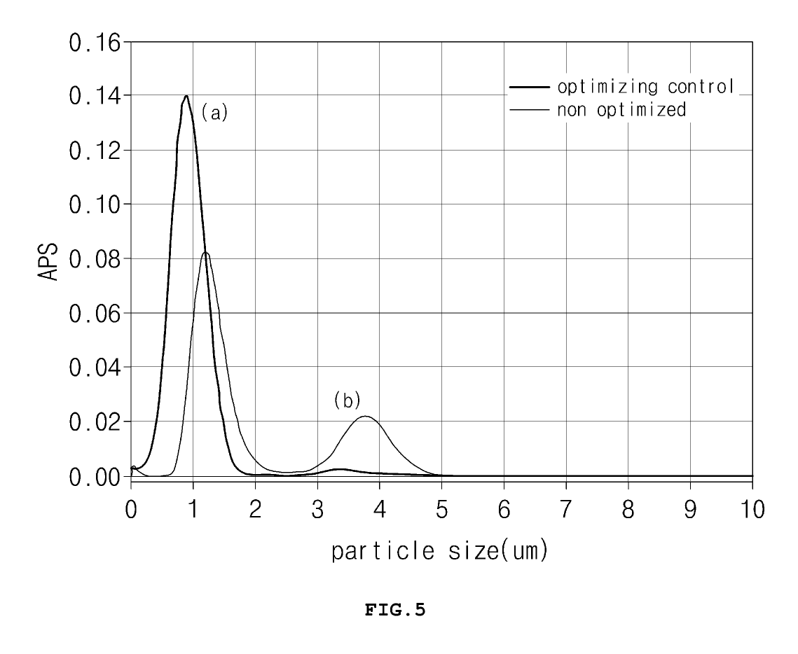

In FIG. 5, the curve B shows the catalyst particle size distribution of the catalyst slurry prepared using a prior art high-speed dispersed method. The degree of the catalyst dispersion was low, and catalyst particles with a large size ranging from 3 to 5 nm existed in large quantity.

On the contrary, the catalyst particle size distribution of the catalyst slurry prepared using a process of the present invention was substantially uniform (Curve A of FIG. 5). More particularly, no or merely a trace amount of coarse catalyst particles existed and the catalyst particles had a uniform size distribution in 1 nm or so. Compared to the catalyst particle size distribution of the catalyst slurry prepared using the prior art high-speed dispersed method, coarse particles with a size ranging from 0.7 to 2.3 um did not exist, the peak of the particle size distribution was shifted to 0.3 to 1.5 um, and the entire particle distribution was denser.

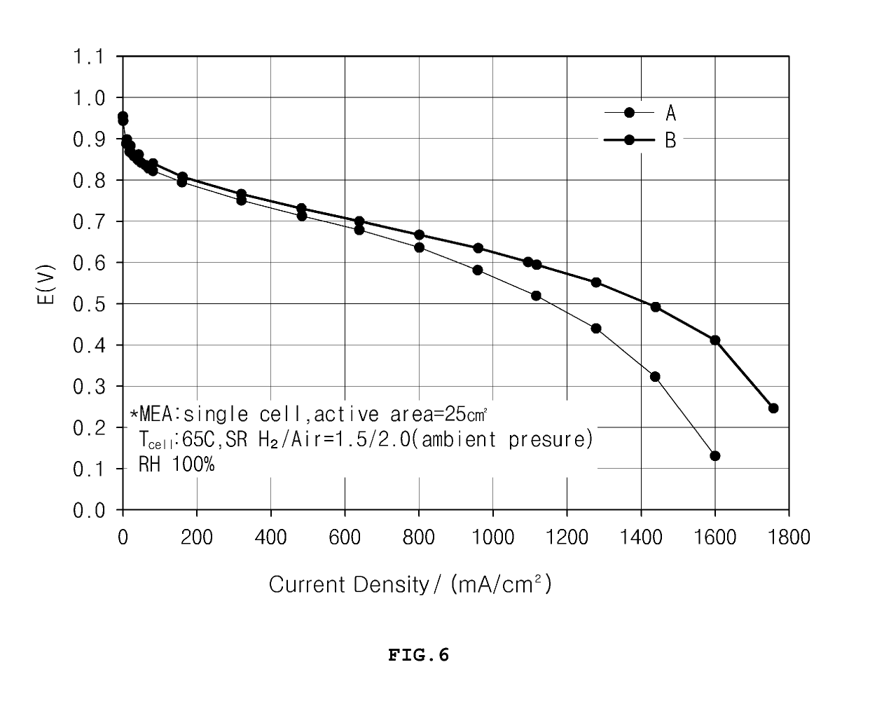

The thus obtained catalyst slurries were used to prepare MEAs. The performance of the respective MEAs was tested and the test result is shown in FIG. 6. In the preparation of the respective MEAs, 0.2 mgPt/cm² and 0.4 mgPt/cm² of catalyst (Pt) were loaded to the anode and the cathode thereof, respectively, a fluorine-based polymer membrane having a thickness of about 30 μm and an EW of about 900 was used as the electrolyte membrane, and Pt/C catalyst containing Pt in an amount of 50% or more based on the total weight of the catalyst was used.

As shown in FIG. 6, the MEA prepared using the catalyst slurry prepared by a process according to the present invention exhibited a current density of 1.2 A/cm² or so at 0.6 V (Curve B). On the other hand, the MEA prepared using the catalyst slurry prepared by the high-speed dispersion method exhibited a much inferior performance (Curve A). Without intending to limit the theory, it is contemplated that uniform pore size distribution resulting from the present methods increased reaction efficiency inside the catalyst.

As described above, according to the present methods and apparatuses, a vacuum degassing process is introduced in the preparation of the catalyst slurry to create a vacuum state during the dispersion process of a catalyst powder so that oxygen bubbles adsorbed onto the surfaces of the catalyst particles are removed and simultaneously oxygen bubbles inside primary pores escape into a solvent, which can improve dispersion of the catalyst particles in the solvent and flowability of the catalyst slurry.

In addition, the adsorption force between the catalyst and the ionomer can be maximized to uniformly disperse nano-sized catalyst particles at a high concentration, and a high-efficiency catalyst electrode and a high-performance MEA for fuel cells can be manufactured.

The invention has been described in detain with reference to preferred embodiments thereof. However, it will be appreciated by those skilled in the art that changes may be made in these embodiments without departing from the principles and spirit of the invention, the scope of which is defined in the appended claims and their equivalents.

1-3. (canceled)

4. An apparatus for preparing a catalyst slurry for fuel cells, comprising:
a reactor for accommodating a solvent and a catalyst therein;
an ultrasonic generator and a high-speed stirrer which are connected to the reactor so as to uniformly disperse the catalyst to a predetermined particle size in the solvent; and
vacuum maintaining means connected to the reactor so as to maintain the internal pressure of the reactor in a vacuum state.

5. The apparatus according to claim 4, wherein the vacuum maintaining means comprises:
an air escape tube provided at the reactor so as to allow internal air of the reactor to escape therethrough; and
a vacuum pump for creating a vacuum state inside the reactor by allowing the internal air of the reactor to escape through the air escape tube.

6. The apparatus according to claim 5, wherein the reactor includes a hopper through which the catalyst powder can be charged into the reactor and a spray nozzle through which water can be sprayed onto the catalyst powder introduced into the hopper.

7. The apparatus according to claim 6, further comprising a bead milling machine connected to the reactor so as to bead milling the catalyst particles having a particle size large than a reference particle size among the catalyst particles stirred and dispersed in the reactor.
